(19) United States
(12) Patent Application Publication
(10) Pub. No.: US 2018/0048877 A1
(43) Pub. Date: Feb. 15, 2018

(54) FILE FORMAT FOR INDICATION OF VIDEO CONTENT

(71) Applicant: MEDIATEK INC., Hsin-Chu City (TW)

(72) Inventors: Wang Lin Lai, San Jose, CA (US); Shan Liu, San Jose, CA (US)

(73) Assignee: MEDIATEK INC., Hsin-Chu City (TW)

(21) Appl. No.: 15/663,932

(22) Filed: Jul. 31, 2017

Related U.S. Application Data
(60) Provisional application No. 62/372,824, filed on Aug. 10, 2016.
(60) Provisional application No. 62/382,805, filed on Sep. 2, 2016.

(51) Int. Cl. H04N 13/00

(52) U.S. Cl. CPC H04N 13/0066; H04N 13/0011

(57) ABSTRACT

Aspects of the disclosure provide an apparatus that includes an interface circuit, a processing circuit, and a display device. The interface circuit is configured to receive media data with video content being structured into one or more tracks corresponding to one or more spatial partitions. The media data includes a correspondence of the one or more tracks to the one or more spatial partitions. The processing circuit is configured to extract the correspondence of the one or more tracks to the one or more spatial partitions, select, from the one or more tracks, one or more covering tracks with spatial partitions covering a region of interest based on the correspondence, and generate images of the region of interest based on the one or more covering tracks. The display device is configured to display the images of the region of interest.

### INCORPORATION BY REFERENCE

This present disclosure claims the benefit of U.S. Provisional Application No. 62/372,824, “Methods and Apparatus of Indications of VR and 360 video Content in File Formats” filed on Aug. 10, 2016, and U.S. Provisional Application No. 62/382,805, “Methods and Apparatus of Indications of VR in File Formats” filed on Sep. 2, 2016, which are incorporated herein by reference in their entirety.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Omnidirectional video/360 video can be rendered to provide special user experience. For example, in a virtual reality application, computer technologies create realistic images, sounds and other sensations that replicate a real environment or create an imaginary setting, thus a user can have a simulated omnidirectional video/360 video experience of a physical presence in a environment.

### SUMMARY

Aspects of the disclosure provide an apparatus that includes an interface circuit, a processing circuit, and a display device. The interface circuit is configured to receive media data with video content being structured into one or more tracks corresponding to one or more spatial partitions. The media data includes a correspondence of the one or more tracks to the one or more spatial partitions. The processing circuit is configured to extract the correspondence of the one or more tracks to the one or more spatial partitions, select, from the one or more tracks, one or more covering tracks with spatial partitions covering a region of interest based on the correspondence, and generate images of the region of interest based on the one or more covering tracks. The display device is configured to display the images of the region of interest.

According to an aspect of the disclosure, the processing circuit is configured to determine a correspondence of a track to a spatial partition based on spatial partition information associated with the track.

According to an aspect of the disclosure, the processing circuit is configured to determine a projection type based on a projection indicator, and determine the correspondence based on the projection type. In an embodiment, the processing circuit is configured to extract values in a spherical coordinate system that define the spatial partition when the projection indicator is indicative of equirectangular projection (ERP). For example, the processing circuit is configured to determine a center point and a field of view that define the spatial partition based on the values in the spherical coordinate system. In another example, the processing circuit is configured to determine boundaries that define the spatial partition based on the values in the spherical coordinate system.

In another embodiment, the processing circuit is configured to extract a face index that identifies the spatial partition when the projection indicator is indicative of platonic solid projection.

Aspects of the disclosure provide a method for image rendering. The method includes receiving media data with video content being structured into one or more tracks corresponding to one or more spatial partitions. The media data includes a correspondence of the one or more tracks to the one or more spatial partitions. Further, the method includes extracting the correspondence of the one or more tracks to the one or more spatial partitions, selecting, from the one or more tracks, one or more covering tracks with spatial partitions covering a region of interest based on the correspondence, generating images of the region of interest based on the one or more covering tracks, and displaying the images of the region of interest.

Aspects of the disclosure provide an apparatus that includes a memory and a processing circuit. The memory is configured to buffer captured media data. The processing circuit is configured to structure video content of the captured media data into one or more tracks corresponding to one or more spatial partitions, encode the media data and encapsulate the encoded media data with a correspondence of the one or more tracks to the one or more spatial partitions into one or more files.

Aspects of the disclosure provide a method. The method includes receiving captured media data, structuring video content of the captured media data into one or more tracks corresponding to one or more spatial partitions, encoding the media data and encapsulating the encoded media data with a correspondence of the one or more tracks to the one or more spatial partitions into one or more files.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of a media system 100 according to an embodiment of the disclosure;

FIG. 2 shows a flow chart outlining a process example 200 according to an embodiment of the disclosure;

FIG. 3 shows a flow chart outlining a process example 300 according to an embodiment of the disclosure; and

FIGS. 4-8 show correspondence examples in file formats according to embodiments of the disclosure.

### DETAILED DESCRIPTION OF EMBODIMENTS

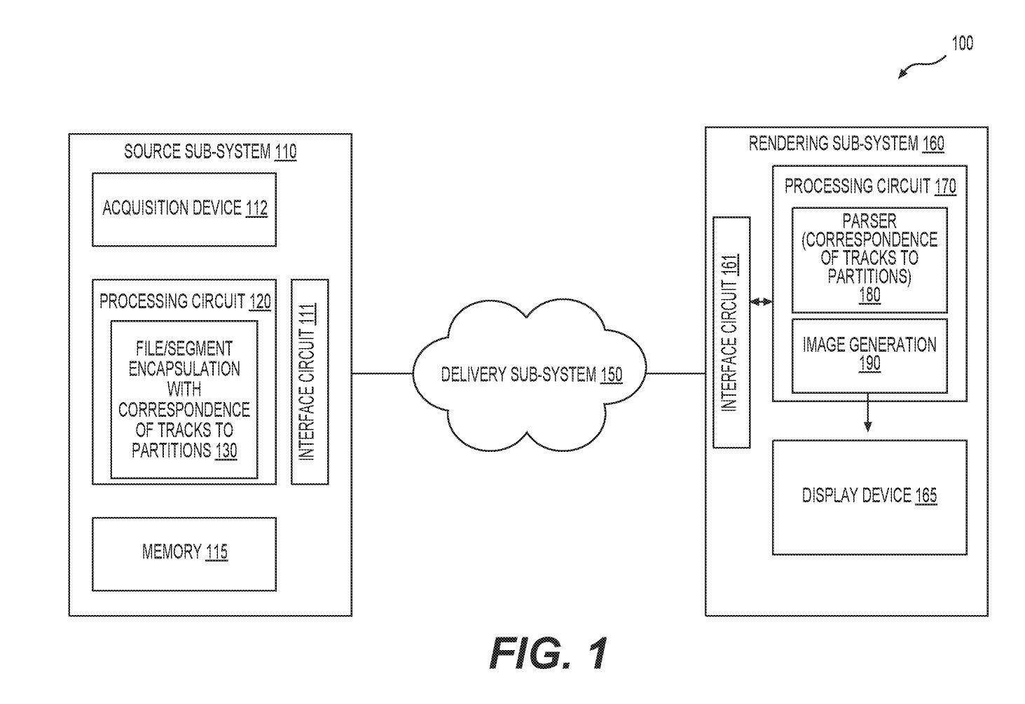

FIG. 1 shows a block diagram of a media system 100 according to an embodiment of the disclosure. The media system 100 includes a source system 110, a delivery system 150 and a rendering system 160 coupled together. The source system 110 is configured to acquire media data for omnidirectional video/360 video and suitably encapsulate the media data. The delivery system 150 is configured to deliver the encapsulated media data from the source system 110 to the rendering system 160. The rendering system 160 is configured to render omnidirectional video/360 video according to the media data.

According to an aspect of the disclosure, the source system 110 structures media data logically in one or more tracks, and each track includes a sequence of samples in time order. In an embodiment, the source system 110 structures image/video data into one or more tracks according to spatial partitions. The one or more tracks are encapsulated in one or more files. Further, the source system 110 includes a correspondence between a track and a spatial partition to assist rendering. Thus, in an example, based on the correspondence, the rendering system 160 can fetch appropriate tracks to generate images of a region of interests.

The source system 110 can be implemented using any suitable technology. In an example, components of the source system 110 are assembled in a device package. In another example, the source system 110 is a distributed system, components of the source system 110 can be arranged at different locations, and are suitable coupled together for example by wire connections and/or wireless connections.

In the FIG. 1 example, the source system 100 includes an acquisition device 112, a processing circuit (e.g., an image generating circuit) 120, a memory 115, and an interface circuit 111 coupled together.

The acquisition device 112 is configured to acquire various media data, such as images, sound, and the like of omnidirectional video/360 video. The acquisition device 112 can have any suitable settings. In an example, the acquisition device 112 includes a camera rig (not shown) with multiple cameras, such as an imaging system with two fisheye cameras, a tetrahedral imaging system with four cameras, a cubic imaging system with six cameras, an octahedral imaging system with eight cameras, an icosahedral imaging system with twenty cameras, and the like, configured to take images of various directions in a surrounding space.

In an embodiment, the images taken by the cameras are overlapping, and can be stitched to provide a larger coverage of the surrounding space than a single camera. In an example, the images taken by the cameras can provide 360° sphere coverage of the whole surrounding space. It is noted that the images taken by the cameras can provide less than 360° sphere coverage of the surrounding space.

The media data acquired by the acquisition device 112 can be suitably stored or buffered, for example in the memory 115. The processing circuit 120 can access the memory 115, process the media data, and encapsulate the media data in suitable format. The encapsulated media data is then suitably stored or buffered, for example in the memory 115.

In an embodiment, the processing circuit 120 includes an audio processing path configured to process audio data, and includes an image/video processing path configured to process image/video data. The processing circuit 120 then encapsulates the audio, image and video data with metadata according to a suitable format.

In an example, on the image/video processing path, the processing circuit 120 can stitch images taken from different cameras together to form a stitched image, such as an omnidirectional image, and the like. Then, the processing circuit 120 can project the omnidirectional image according to suitable two-dimension (2D) plane to convert the omnidirectional image to 2D images that can be encoded using 2D encoding techniques. Then the processing circuit 120 can suitably encode the image and/or a stream of images.

It is noted that the processing circuit 120 can project the omnidirectional image according to any suitable projection technique. In an example, the processing circuit 120 can project the omnidirectional image using equirectangular projection (ERP). The ERP projection projects a sphere surface, such as omnidirectional image, to a rectangular plane, such as a 2D image, in a similar manner as projecting earth surface to a map. In an example, the sphere surface (e.g., earth surface) uses spherical coordinate system of yaw (e.g., longitude) and pitch (e.g., latitude), and the rectangular plane uses XY coordinate system. During the projection, the yaw circles are transformed to the vertical lines and the pitch circles are transformed to the horizontal lines, the yaw circles and the pitch circles are orthogonal in the spherical coordinate system, and the vertical lines and the horizontal lines are orthogonal in the XY coordinate system.

In another example, the processing circuit 120 can project the omnidirectional image to faces of platonic solid, such as tetrahedron, cube, octahedron, icosahedron, and the like. The projected faces can be respectively rearranged, such as rotated, relocated to form a 2D image. The 2D images are then encoded.

It is noted that, in an embodiment, the processing circuit 120 can encode images taken from the different cameras, and does not perform the stitch operation and/or the projection operation on the images.

It is also noted that the processing circuit 120 can encapsulate the media data using any suitable format. In an embodiment, the media data is encapsulated in a single track. For example, the ERP projection projects a sphere surface to a rectangular plane, and the single track can include a flow of the entire rectangular images of the rectangular plane.

In another embodiment, the media data is encapsulated in multiple tracks. In an example, the ERP projection projects a sphere surface to a rectangular plane, and the rectangular plane is divided into multiple partitions (also known as “sub-pictures”). A timed sequence of images of a partition forms a track. Thus, video content of the sphere surface are structured into multiple tracks corresponding to the multiple partitions.

In another example, the platonic solid projection projects a sphere surface into faces of a platonic solid. In the example, the sphere surface is partitioned according to the faces of the platonic solid. A timed sequence of images on a face forms a track. Thus, video content of the sphere surface are structured into multiple tracks corresponding to the faces of the platonic solid.

In another example, multiple cameras are configured to take images in different directions of a scene. In the example, the scene is partitioned according to the field of views of the cameras. A timed sequence of images from a camera forms a track. Thus, video content of the scene is structured into multiple tracks corresponding to the multiple cameras.

According to an aspect of the disclosure, the processing circuit 120 is configured to generate a correspondence between tracks and spatial partitions, and include the correspondence with the media data. In an example, the processing circuit 120 includes a file/segment encapsulation module 130 configured to encapsulate the correspondence of tracks to spatial partitions in files and/or segments. The correspondence can be used to assist a rendering system, such as the rendering system 160, to fetch appropriate tracks and render images of the region of interests.

In an embodiment, the processing circuit 120 is configured to use an extensible format standard, such as ISO base media file format and the like for time-based media, such as video and/or audio. In an example, the ISO base media file format defines a general structure for time-based multimedia files, and is flexible and extensible that facilitates interchange, management, editing and presentation of media. The ISO base media file format is independent of particular network protocol, and can support various network protocols in general. Thus, in an example, presentations based on files in the ISO base media file format can be rendered locally, via network or via other stream delivery mechanism.

Generally, a media presentation can be contained in one or more files. One specific file of the one or more files includes metadata for the media presentation, and is formatted according to a file format, such as the ISO base media file format. The specific file can also include media data. When the media presentation is contained in multiple files, the other files can include media data. In an embodiment, the metadata is used to describe the media data by reference. Thus, in an example, the media data is stored in a state not favoring any protocol. The same media data can be used for local presentation, multiple protocols, and the like. The media data can be stored with or without order.

Specifically, the ISO base media file format includes a specific collection of boxes. The boxes are the logical containers. Boxes include descriptors that hold parameters derived from the media content and media content structures. The media is encapsulated in a hierarchy of boxes. A box is an object-oriented building block defined by a unique type identifier and length.

In an example, the presentation of media content is referred to as a movie and is logically divided into tracks, such as parallel tracks. Each track represents a timed sequence of logical samples of media content. Media content are stored and accessed by access units, such as frames, and the like. The access unit is defined as the smallest individually accessible portion of data within an elementary stream, and unique timing information can be attributed to each access unit. In an embodiment, access units can be stored physically in any sequence and/or any grouping, intact or subdivided into packets. The ISO base media file format uses the boxes to map the access units to a stream of logical samples using references to byte positions where the access units are stored. In an example, the logical sample information allows access units to be decoded and presented synchronously on a timeline, regardless of storage.

According to an aspect of the disclosure, the processing circuit 120 is configured to include correspondence of tracks to spatial partitions into the metadata for tracks. In an embodiment, the processing circuit 120 is configured to use a track box to include metadata for the track. The processing circuit 120 can include description of the spatial partition in the metadata for the track. For example, the processing circuit 120 can includes the description of the spatial partition in a sub-box of the track box. The description of the spatial partition can be suitably provided based on the partition characteristics.

In an embodiment, video contents of a sphere surface are projected to a rectangular plane according to ERP projection, and the rectangular plane is divided into multiple partitions (sub-pictures). In the embodiment, the description of the spatial partitions (sub-pictures) is provided in a spherical coordinate system. In an example, the spatial partition is defined by a center point and a field of view. The center point is provided as a center in yaw dimension (center_yaw) and a center in pitch dimension (center_pitch) and the field of view is provided as a field of view in yaw dimension (fov_yaw) and a field of view in pitch dimension (fov_pitch). In another example, the spatial partition is defined by boundaries, such as a minimum yaw value (yaw_left), a maximum yaw value (yaw_right), a minimum pitch value (pitch_bot), and a maximum pitch value (pitch_top).

In another embodiment, the platonic solid projection projects a sphere surface into faces of a platonic solid, thus the sphere surface is partitioned according to the faces of the platonic solid. In the embodiment, the description of the spatial partitions is provided using face indexes. In the example, a spatial partition can be identified based on the number of faces (num_faces) of the platonic solid and a face index (face_id) for a face corresponding to the spatial partition.

In an embodiment, multiple cameras are configured to take images in different directions of a scene. In the embodiment, the scene is partitioned according to the field of views of the cameras (sub-picture equals to the camera captured picture). In an example, a spatial partition can be identified based on characteristics of corresponding camera, such as field of view of the camera, and the like.

In an embodiment, the processing circuit 120 is implemented using one or more processors, and the one or more processors are configured to execute software instructions to perform media data processing. In another embodiment, the processing circuit 120 is implemented using integrated circuits.

In the FIG. 1 example, the encapsulated media data is provided to the delivery system 150 via the interface circuit 111. The delivery system 150 is configured to suitably provide the media data to client devices, such as the rendering system 160. In an embodiment, the delivery system 150 includes servers, storage devices, network devices and the like. The components of the delivery system 150 are suitably coupled together via wired and/or wireless connections. The delivery system 150 is suitably coupled with the source system 110 and the rendering system 160 via wired and/or wireless connections.

The rendering system 160 can be implemented using any suitable technology. In an example, components of the rendering system 160 are assembled in a device package. In another example, the rendering system 160 is a distributed system, components of the source system 110 can be located at different locations, and are suitable coupled together by wire connections and/or wireless connections.

In the FIG. 1 example, the rendering system 160 includes an interface circuit 161, a processing circuit 170 and a display device 165 coupled together. The interface circuit 161 is configured to suitably receive files of media presentation via any suitable communication protocol.

The processing circuit 170 is configured to process the media data and generate images for the display device 165 to present to one or more users. The display device 165 can be any suitable display, such as a television, a smart phone, a wearable display, a head-mounted device, and the like.

According to an aspect of the disclosure, the processing circuit 170 is configured to determine a correspondence of tracks to spatial partitions from metadata of a media presentation. Then, the processing circuit 170 is configured to determine one or more cover tracks with spatial partitions that cover a region of interest based on the correspondence. Then the one or more cover tracks can be fetched, and the processing circuit 170 can generate one or more images for the region of interest based on the one or more cover tracks.

In an embodiment, the processing circuit 170 is configured to request suitable media data, such as a specific track, from the delivery system 150 via the interface circuit 161. In another embodiment, the processing circuit 170 is configured to fetch a specific track from a locally stored file.

In an example, the processing circuit 170 includes a parser module 180 and an image generation module 190. The parser module 180 is configured to parse the metadata to extract the correspondence of tracks to spatial partitions from metadata. The image generation module 190 is configured to generate images of the region of interests. The parser module 180 and the image generation module 190 can be implemented as processors executing software instructions and can be implemented as integrated circuits.

In an embodiment, description of the spatial partitions is provided in a spherical coordinate system. In an example, the parser module 180 extracts, from metadata of a track, values in the spherical coordinate system for a center point and a field of view that define a spatial partition. In another example, the parser module 180 extracts, from metadata of a track, values in the spherical coordinate system that define boundaries of a spatial partition.

In another embodiment, description of the spatial partitions is provided as face indexes for a platonic solid. In an example, the parser module 180 extracts, from metadata of a track, the number of faces of the platonic solid and a face index for a face that identifies a spatial partition.

In an embodiment, description of the spatial partitions is provided as characteristics of cameras. In an example, the parser module 180 extracts, from the metadata of a track, the characteristics of a camera, and determines the spatial partition based on the characteristics.

In an embodiment, the processing circuit 170 is implemented using one or more processors, and the one or more processors are configured to execute software instructions to perform media data processing. In another embodiment, the processing circuit 170 is implemented using integrated circuits.

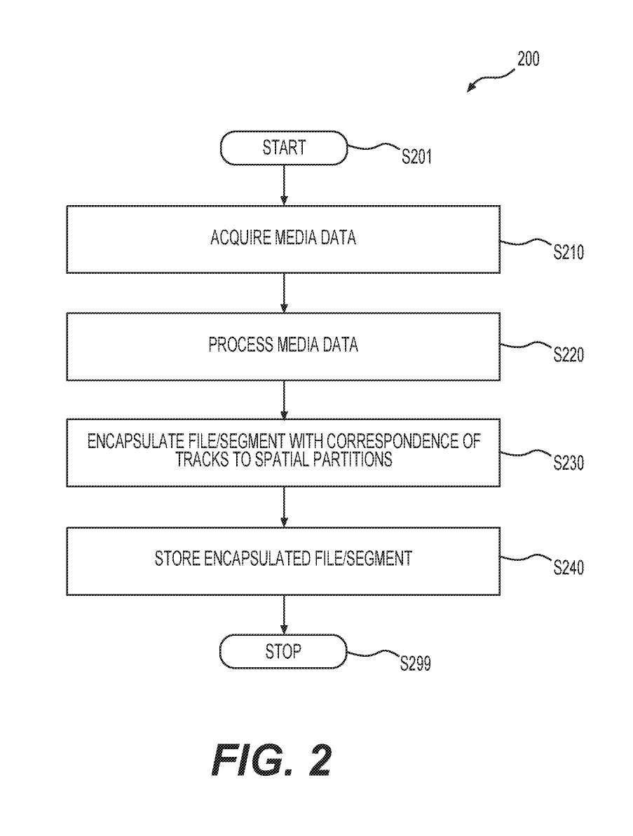

FIG. 2 shows a flow chart outlining a process example 200 according to an embodiment of the disclosure. In an example, the process 200 is executed by a source system, such as the source system 110 in the FIG. 1 example. The process starts at S201 and proceeds to S210.

At S210, media data is acquired. In the FIG. 1 example, the acquisition device 112 acquires various media data, such as images, sound, and the like for omnidirectional video/360 video. In an example, the acquisition device 112 includes multiple cameras configured to take images of different directions in a surrounding space. In an example, the images taken by the cameras can provide 360° sphere coverage of the whole surrounding space. It is noted that the images taken by the cameras can provide less than 360° sphere coverage of the surrounding space. The media data acquired by the acquisition device 112 can be suitably stored or buffered, for example in the memory 115.

At S220, the media data is processed. In the FIG. 1 example, the processing circuit 120 includes an audio processing path configured to process audio data, and includes an image/video process path configured to process image/video data. In an example, on the image/video processing path, the processing circuit 120 can stitch images taken from different cameras together to form a stitched image, such as an omnidirectional image, and the like. Then, the processing circuit 120 can project the stitched image according to suitable 2D plane to convert the omnidirectional image to one or more 2D images that can be encoded using 2D encoding techniques. Then the processing circuit 120 can suitably encode the image or a stream of images.

At S230, correspondence of tracks to spatial partitions (sub-pictures) is encapsulated with media data in files/segments. In the FIG. 1 example, the processing circuit 120 is configured to structure video content of a sphere surface in multiple tracks corresponding to spatial partitions of the sphere surface. The processing circuit 120 uses track boxes to include metadata respectively for the multiple tracks, and add description of the spatial partitions in the metadata respectively for the multiple tracks.

At S240, encapsulated files/segments are stored and delivered. In the FIG. 1 example, the encapsulated media data can be stored in the memory 115, and can be provided to the delivery system 150 via the interface circuit 111. The delivery system 150 can suitably deliver the media data to clients, such as the rendering system 160. Then, the process proceeds to S299 and terminates.

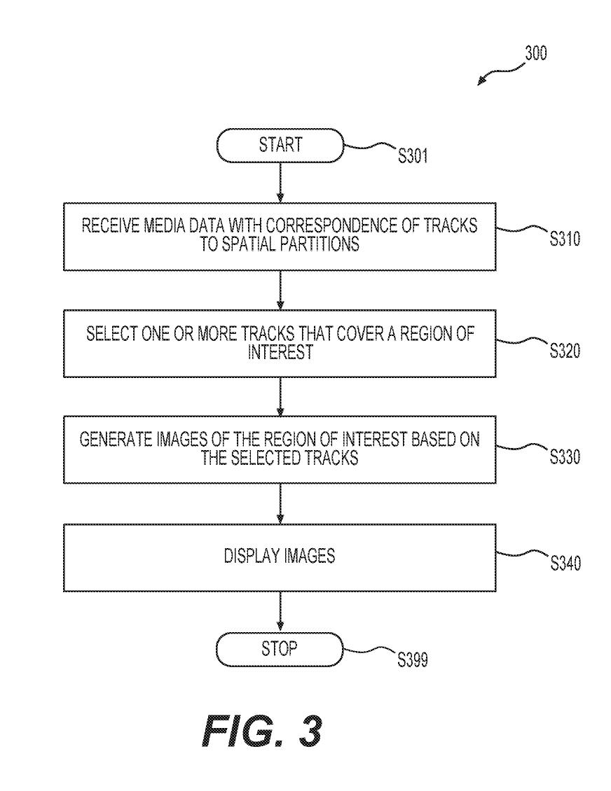

FIG. 3 shows a flow chart outlining a process example 300 according to an embodiment of the disclosure. In an example, the process 300 is executed by a rendering system, such as the rendering system 160 in the FIG. 1 example. The process starts at S301 and proceeds to S310.

At S310, media data with correspondence of tracks to spatial partitions is received. In the FIG. 1 example, the interface circuit 161 in the rendering system 160 suitably receives a file including metadata for a media presentation. In an embodiment, the metadata includes track boxes of metadata respectively for multiple tracks, and includes the description of spatial partitions in the metadata respectively for the multiple tracks.

At S320, one or more tracks are selected that the spatial partitions of the tracks cover a region of interest. In the FIG. 1 example, the processing circuit 170 can determine a region of interest, and determine spatial partitions that cover the region of interest based on the description of the spatial partitions. Then, the processing circuit 170 can select the tracks corresponding to the determined spatial partitions, and suitably fetch the selected tracks accordingly. In an embodiment, the processing circuit 170 is configured to request suitable media data, such as a specific track of media data from the delivery system 150.

At S330, images to render views for the region of interests are generated. In the FIG. 1 example, the processing circuit 170 is configured to generate one or more images of the region of interests based on selected tracks.

At S340, images are displayed. In the FIG. 1 example, the display device 165 suitably presents the images to one or more users. Then, the process proceeds to S399 and terminates.

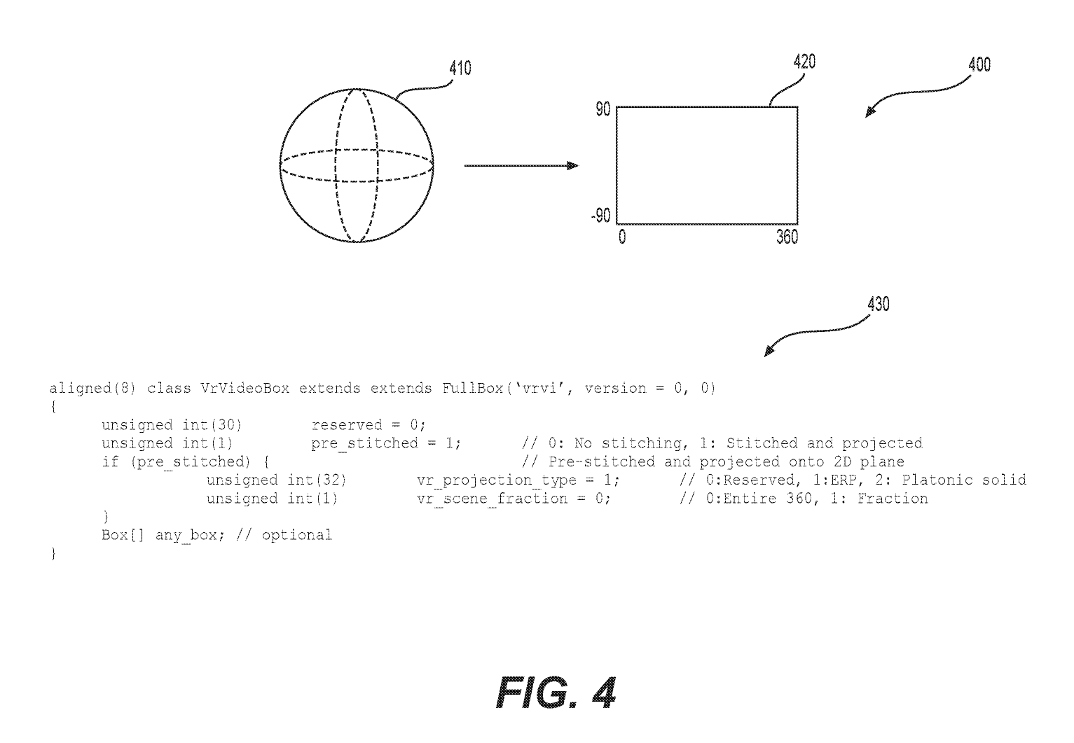

FIG. 4 shows a correspondence example 400 of a track to a spatial partition according to an embodiment of the disclosure.

In the FIG. 4 example, video content of a sphere surface 410 is projected to a rectangular plane 420 according to ERP projection. Images of the rectangular plane 420 form a stream, and are structured in a single track. Thus, the track and the entire rectangular plane have a corresponding relationship. In an embodiment, the corresponding relationship is identified in metadata that is encapsulated in a file according to a file format, such as the ISO base media file format.

In the FIG. 4 example, a box 430 is used to define a spatial partition. In an example, the box 430 is a sub-box for a track box, such as a box with ‘trak’ type, such that a track defined by the track box corresponds to the spatial partition defined in the box 430.

In the FIG. 4 example, the box 430 defines a spatial partition as the whole rectangular plane 420. Thus, each sample in the track covers the entire rectangular plane 420.

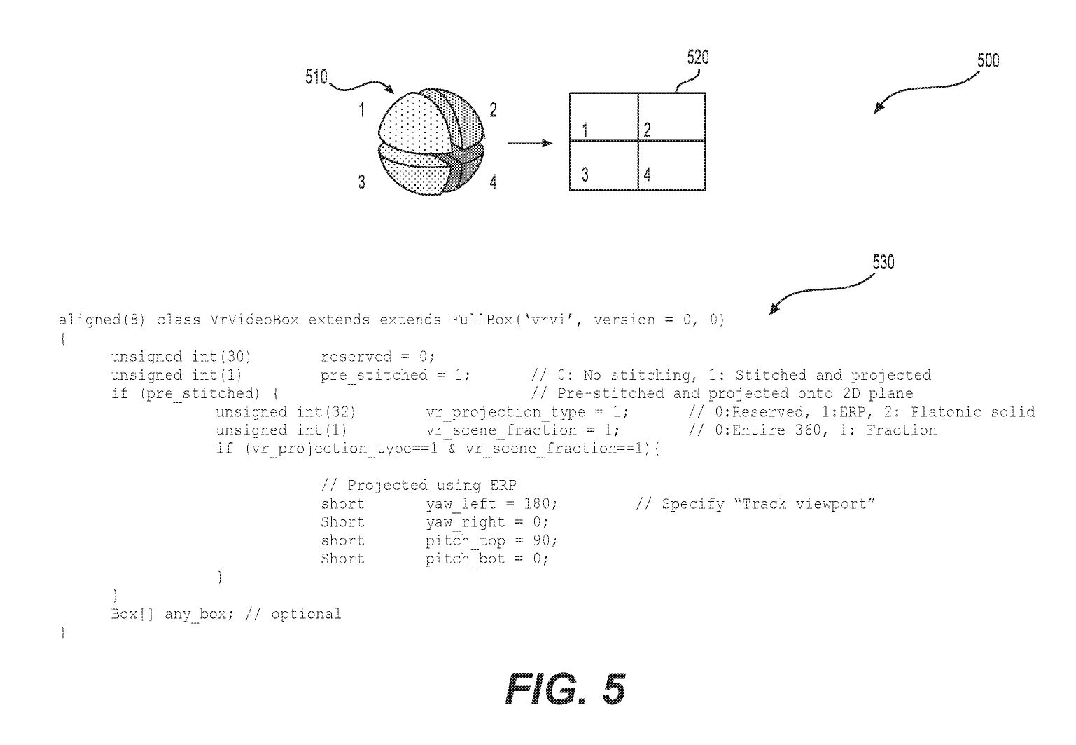

FIG. 5 shows a correspondence example 500 of a track to a spatial partition according to an embodiment of the disclosure.

In the FIG. 5 example, video content of a sphere surface 510 is projected to a rectangular plane 520 according to ERP projection. The rectangular plane 520 is divided into 1-4 partitions. Images of each partition form a stream, and are structured in a track. Thus, tracks and partitions 1-4 have a corresponding relationship. In an embodiment, the corresponding relationship is identified in metadata that is encapsulated in a file according to a file format, such as the ISO base media file format.

In the FIG. 5 example, a box 530 is used to define the partition 2. In an example, the box 530 is a sub-box for a track box, such as a box with ‘trak’ type, such that a track defined by the track box corresponds to the partition 2 defined in the box 530.

In the FIG. 5 example, the box 530 defines partition 2 using spherical coordinates system. For example, yaw_left with value “180” defines the left boundary of the partition 2, yaw_right with value “0” (same to 360 in spherical coordinates system) defines the right boundary of the partition 2, pitch_top with value “90” defines the top boundary of the partition 2, and the pitch_bot with value “0” defines the bottom boundary of the partition 2.

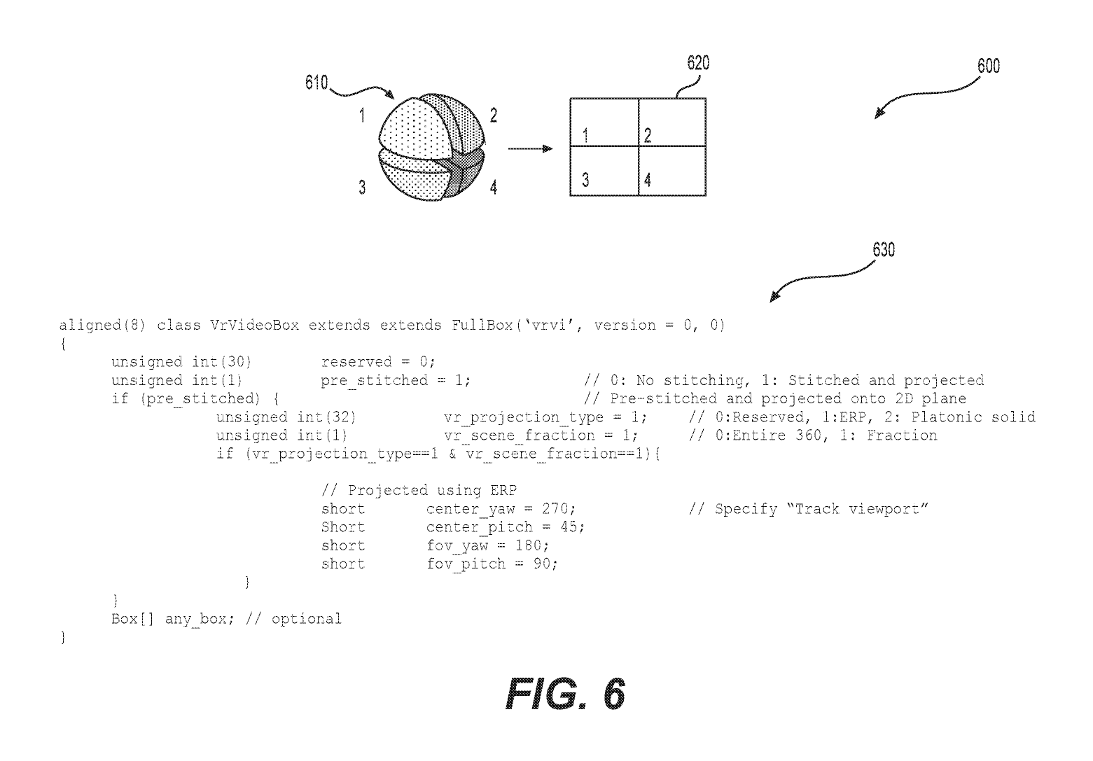

FIG. 6 shows a correspondence example 600 of a track to a spatial partition according to an embodiment of the disclosure.

In the FIG. 6 example, video content of a sphere surface 610 is projected to a rectangular plane 620 according to ERP projection. The rectangular plane 620 is divided into 1-4 partitions. Images of each partition form a stream, and are structured in a track. Thus, tracks and partitions 1-4 have a corresponding relationship. In an embodiment, the corresponding relationship is identified in metadata that is encapsulated in a file according to a file format, such as the ISO base media file format.

In the FIG. 6 example, a box 630 is used to define the partition 2. In an example, the box 630 is a sub-box for a track box, such as a box with ‘trak’ type, such that a track defined by the track box corresponds to the partition 2 defined in the box 630.

In the FIG. 6 example, the box 630 defines partition 2 using spherical coordinates system. For example, center_yaw with value “270” and center_pitch with value “45” define the center point of the partition 2, fov_yaw with value “180” defines a coverage in in yaw dimension, and the fov_pitch with value “90” defines a coverage in pitch dimension.

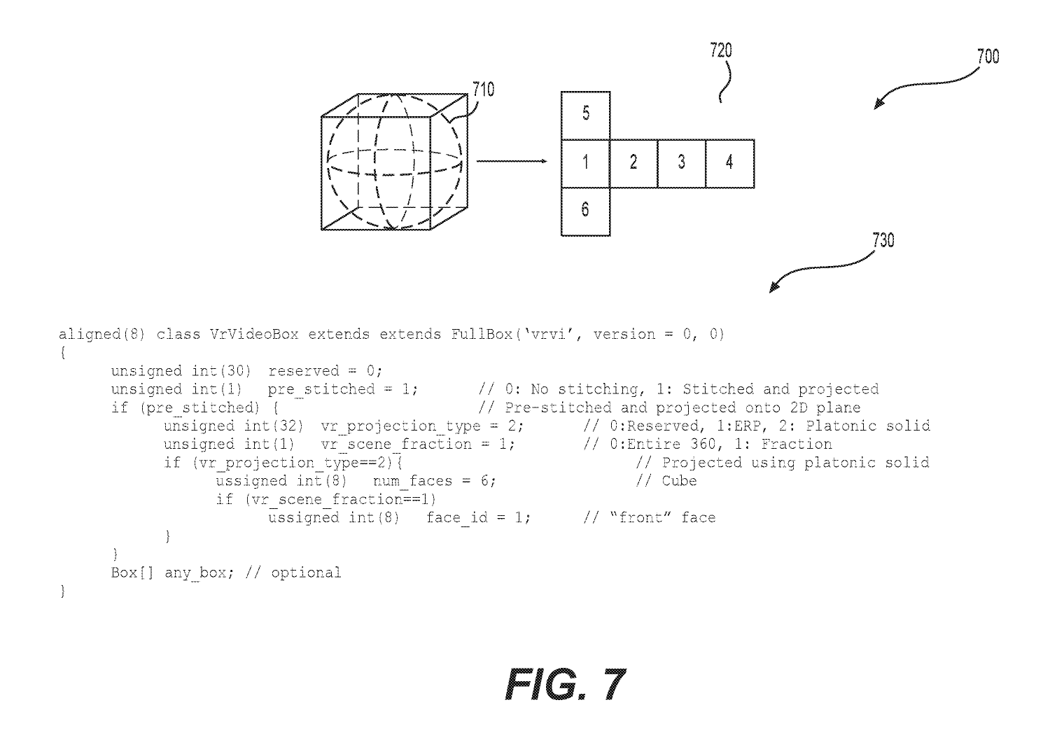

FIG. 7 shows a correspondence example 700 of a track to a spatial partition according to an embodiment of the disclosure.

In the FIG. 7 example, video content of a sphere surface 710 is projected to faces 1-6 of a cube, and the faces 1-6 are re-arranged to form a 2D plane 720. In the example, partitions of the 2D plane 720 align with the boundaries of the faces 1-6, thus the face indexes can be used to identify the partitions. In an example, images of a face form a stream, and are structured in a track. Thus, tracks and faces have a corresponding relationship. In an embodiment, the corresponding relationship is identified in metadata that is encapsulated in a file according to a file format, such as the ISO base media file format.

In the FIG. 7 example, a box 730 is used to define a partition using face index. In an example, the box 730 is a sub-box for a track box, such as a box with ‘trak’ type, such that a track defined by the track box corresponds to the partition identified by the box 730.

In the FIG. 7 example, the box 730 identifies that the projection type is platonic solid projection. Further, the box 730 identifies that the number of faces is 6, thus the platonic solid is a cube. Then, the box 730 uses the face_id with value “1” to define and identify the partition.

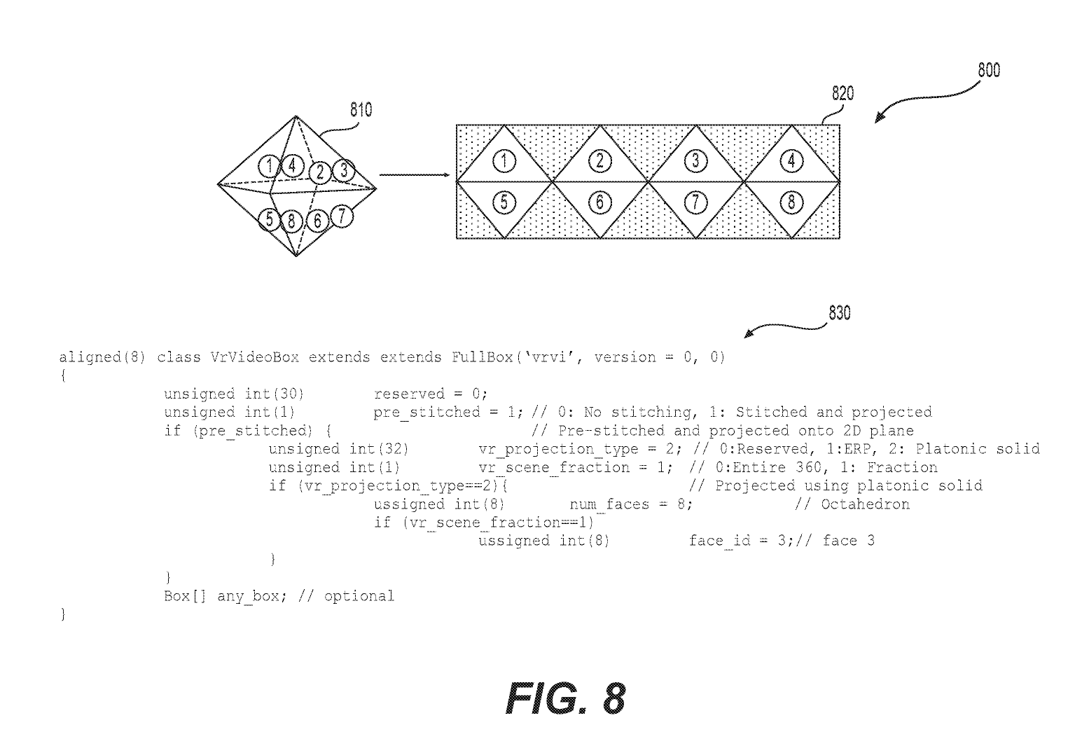

FIG. 8 shows a correspondence example 800 of a track to a spatial partition according to an embodiment of the disclosure.

In the FIG. 8 example, video content of a sphere surface is projected to faces 1-8 of an octahedron, and the faces 1-8 are re-arranged to form a 2D plane 820. In the example, partitions of the 2D plane 820 align with the boundaries of the faces 1-8, thus the face indexes can be used to identify the partitions. In an example, images of a face form a stream, and are structured in a track. Thus, tracks and faces have a corresponding relationship. In an embodiment, the corresponding relationship is identified in metadata that is encapsulated in a file according to a file format, such as the ISO base media file format.

In the FIG. 8 example, a box 830 is used to define a partition using face index. In an example, the box 830 is a sub-box for a track box, such as a box with ‘trak’ type, such that a track defined by the track box corresponds to the partition identified by the box 830.

In the FIG. 8 example, the box 830 identifies that the projection type is platonic solid projection. Further, the box 830 identifies that the number of faces is 8, thus the platonic solid is an octahedron. Then, the box 830 uses the face_id with value “3” to define and identify the partition.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. An apparatus, comprising:
an interface circuit (161) configured to receive media data with video content being structured into one or more tracks corresponding to one or more spatial partitions, the media data including a correspondence of the one or more tracks to the one or more spatial partitions;
a processing circuit (170) configured to extract the correspondence of the one or more tracks to the one or more spatial partitions, select, from the one or more tracks, one or more covering tracks with spatial partitions covering a region of interest based on the correspondence, and generate images of the region of interest based on the one or more covering tracks; and
a display device configured to display the images of the region of interest.

2. The apparatus of claim 1, wherein the processing circuit is configured to determine a correspondence of a track to a spatial partition based on spatial partition information associated with the track.

3. The apparatus of claim 2, wherein the processing circuit is configured to determine a projection type based on a projection indicator, and determine the correspondence based on the projection type.

4. The apparatus of claim 3, wherein the processing circuit is configured to extract values in a spherical coordinate system that define the spatial partition when the projection indicator is indicative of equirectangular projection (ERP).

5. The apparatus of claim 4, wherein the processing circuit is configured to determine a center point and a field of view that define the spatial partition based on the values in the spherical coordinate system.

6. The apparatus of claim 4, wherein the processing circuit is configured to determine boundaries that define the spatial partition based on the values in the spherical coordinate system.

7. The apparatus of claim 3, wherein the processing circuit is configured to extract a face index that identifies the spatial partition when the projection indicator is indicative of platonic solid projection.

8. A method for image rendering, comprising:
receiving media data with video content being structured into one or more tracks corresponding to one or more spatial partitions, the media data including a correspondence of the one or more tracks to the one or more spatial partitions;
extracting the correspondence of the one or more tracks to the one or more spatial partitions;
selecting, from the one or more tracks, one or more covering tracks with spatial partitions covering a region of interest based on the correspondence;
generating images of the region of interest based on the one or more covering tracks; and
displaying the images of the region of interest.

9. The method of claim 8, wherein extracting the correspondence of the one or more tracks to the one or more spatial partition further comprises:
determining a correspondence of a track to a spatial partition based on spatial partition information associated with the track.

10. The method of claim 9, wherein extracting the correspondence of the one or more tracks to the one or more spatial partition further comprises:
determining a projection type based on a projection indicator; and
determining the correspondence based on the projection type.

11. The method of claim 10, further comprising:
extracting values in a spherical coordinate system that define the spatial partition when the projection indicator is indicative of equirectangular projection (ERP).

12. The method of claim 11, further comprising:
determining a center point and a field of view that define the spatial partition based on the values in the spherical coordinate system.

13. The method of claim 11, further comprising:
determining boundaries that define the spatial partition based on the values in the spherical coordinate system.

14. The method of claim 10, further comprising:
extracting a face index that identifies the spatial partition when the projection indicator is indicative of platonic solid projection.

15. An apparatus, comprising:
a memory (115) configured to buffer captured media data; and
a processing circuit (120) configured to structure video content of the captured media data into one or more tracks corresponding to one or more spatial partitions, encode the media data and encapsulate the encoded media data with a correspondence of the one or more tracks to the one or more spatial partitions into one or more files.

16. The apparatus of claim 15, wherein the processing circuit is configured to associate spatial partition information of a track with a description of the track.

17. The apparatus of claim 16, wherein the processing circuit is configured to include a projection indicator that is indicative of a projection type, and include the spatial partition information associated with the projection type.

18. The apparatus of claim 17, wherein the processing circuit is configured to include values in a spherical coordinate system that define the spatial partition when the projection indicator is indicative of equirectangular projection (ERP).

19. The apparatus of claim 17, wherein the processing circuit is configured to include a face index that identifies the spatial partition when the projection indicator is indicative of platonic solid projection.

20. A method, comprising:
receiving captured media data; and
structuring video content of the captured media data into one or more tracks corresponding to one or more spatial partitions;
encoding the media data; and
encapsulating the encoded media data with a correspondence of the one or more tracks to the one or more spatial partitions into one or more files.
